(19) United States
(12) Patent Application Publication
(10) Pub. No.: US 2017/0036587 A1
(43) Pub. Date: Feb. 9, 2017

(54) MANUALLY OPERATED DUMP AND TRANSPORT TRAILER

(71) Applicant: Peter Ozigbu, Las Vegas, NV (US)

(72) Inventor: Peter Ozigbu, Las Vegas, NV (US)

(21) Appl. No.: 14/820,355

(22) Filed: Aug. 6, 2015

(51) Int. Cl. B60P 1/24; B60P 1/28

(52) U.S. Cl. CPC B60P 1/24; B60P 1/28

(57) ABSTRACT

A manually operated dump trailer provides a holding container positioned on the rear portion of a frame or trailer, which can then be attached to a vehicle to assist in hauling and dumping. The present system includes a locking mechanism configured to secure a container in the holding position. The locking mechanism can be mechanically disengaged to allow a container to move from the holding position to the dumping position, thereby dumping the load from a container.

### CROSS-REFERENCE TO RELATED APPLICATIONS

U.S. Ser. No. 14/62,034,356

### FEDERALLY SPONSORED RESEARCH

None

### SEQUENCE LISTING

None

### TECHNICAL FIELD OF INVENTION (FOI)

This this invention relates to dump and transport trailers that provide functionality for dumping, loading, and unloading using mechanical manipulations. More particularly, the present invention relates to hauling and transporting material via pulled trailer that incorporates a manual and balanced dumping operation and method. The embodiments offer the ability for a single user to transport and dump material, such as dirt, gravel, rocks, and other various material without the need for electronic or powered assistance.

### BACKGROUND

Unpowered trailers that are pulled behind powered vehicles have become commonplace in modern society. Trailers are used for transporting a nearly limitless variety of cargo, including cargo for use in industry, cargo for use in commerce, and cargo for personal use. At a most basic level, most trailers include a bed frame on which loads can be supported, one or more axles to which tires are attached, and a tongue that incorporates a hitch mechanism for attaching the trailer to a vehicle. Due to the vast range of goods and loads that can be transported using trailers, a variety of trailer styles are currently in use.

Some trailer styles incorporate dumping containers that can tilt, most often to the side, to assist with the loading and unloading of goods. These trailers can ease much of the difficulty of unloading a trailer by dumping cargo directly from the bed area. However, dumping bed trailers are commonly associated with additional cost, maintenance, and safety concerns. Many dumping bed trailers employ the use of combustive, electrical, or hydraulic power to raise and lower the dumping bed or pivot the dumping container. For example, in U.S. Pat. No. 2,815,245, the locomotive force of the vehicle attached to the dumping mechanism provides the force for rotating the dump container. While these power sources can ease much of the manual labor required for loading and unloading, the hardware associated with these power sources (e.g., engines, motors, hoses, wiring, gears, belts, etc.) can be expensive to purchase, can involve significant maintenance and repair, and can be dangerous to use. For example, in U.S. Pat. No. 4,968,096, the dumping actuation requires a motor from an attached vehicle to articulate the chassis into the dumping position via a complicated pivotal system prone to failure. It is an object of the present invention to simplify the pivotal system and replace it with a more economical alternative without the need for mechanical assistance.

Some dumping bed trailers operate more simply by enabling the trailer bed to tilt over a single stationary axle. Dumping the trailer then involves tilting the bed by shifting the load on the bed (often towards the rear of the bed) until the bed tilts over the single stationary axle. Often times, this can involve one or more users manually re-adjusting loads, or even standing or jumping on the back of the bed, until the bed tilts. When the bed does tilt, it often does so quickly and can throw the user, shift the load, or otherwise create an unsafe situation. Furthermore, in order to allow these trailers to tip to a dumping position, these trailers usually position the single stationary axle in the middle of the trailer. Placing the axle near the middle of the trailer, as opposed to the rear of the trailer, reduces the stability of the trailer during towing and can cause the trailer to tow improperly or unsafely. Similarly, some users often use stationary bed trailers as dumping bed trailers by unhitching the trailer and shifting the weight on the trailer to cause it to rotate about a stationary axle. This can be particularly unsafe, as an unhitched trailer has a broad freedom of movement.

### SUMMARY

The present disclosure relates to dumping devices configured to occupy a holding position and a dumping position, a container being configured to hold a load when in the holding position, a container having a center of gravity. The dumping devices further comprise a frame configured to support a container, the frame having a forward portion and a rearward portion, and a locking mechanism configured to releasably secure a container in the holding position. A container of the dumping devices may be secured to the frame at a pivot point, the pivot point being located forward of the center of gravity of a container. Disengaging the locking mechanism allows a container to move from the holding position to the dumping position, thereby dumping the load from a container. The devices disclosed herein can be manually operated. Moreover, the dumping devices can be configured to facilitate manual operation even when heavy and/or awkward loads are contained in a container.

According to some embodiments, the frame comprises a trailer configured to be attached to a vehicle. In some embodiments, at least a portion of the frame defines a first plane, and a rearward portion of a container defines a second plane, wherein an angle between the first and second planes is between about 30° and about 60°. In some embodiments, the dumping position is achieved when an angle between the first and second planes is less than 0°.

According to some embodiments, the pivot point is positioned so as to allow a user to manually move a container from the dumping position to the holding position. In some embodiments, the frame further comprises a sliding mechanism configured to allow for the pivot point to be moved relative to the frame so as move a container laterally along the frame from a forward position to a rearward position.

According to some embodiments, the center of gravity of a container—when in the holding position—does not substantially change when a container is filled with a load. In some embodiments, a container comprises four sides, a first side toward the forward portion of the frame two angled sides, a second side toward the rearward portion of the frame, wherein the first and second sides are angled away from each other.

According to some embodiments disclosed herein, the frame is configured to provide a counterbalance to a container when a container is in the dumping position. In some embodiments, a forward portion the frame is secured to a vehicle. In some embodiments, the dumping device of claim 9, wherein the frame further comprises a weighted portion positioned forward of a container.

In some embodiments, the device further comprises a spring mechanism attached to the frame and to a container. In some embodiments, the spring mechanism is configured to halt the movement of a container when it transitions from the holding position to the dumping position. In some embodiments, the spring mechanism is configured to dampen the falling force of a container as it transitions from the holding position to the dumping position. In some embodiments, the spring mechanism is configured to assist a user in returning a container from the dumping position to the holding position. In some embodiments, the spring mechanism comprises a rod connected at a first end to a container and at a second end to a spring, wherein the spring is secured to the frame.

Also disclosed herein are methods of operating a dumping device. Some methods comprise releasing a locking mechanism so to allow a container to transition from a holding position to a dumping position, wherein a container is configured to hold a load when in the holding position, a container being supported by a frame, and wherein a container is secured to the frame at a pivot point, the pivot point being located forward of a center of gravity of a container.

Also disclosed herein are methods of making a dumping device. Some methods comprise the following: providing a frame; providing a container configured to hold a load when in a holding position, a container being secured to the frame by at least one pivot point, a container having a center of gravity, the pivot point being located forward of the center of gravity; and providing a locking mechanism configured to releasably secure a container in the holding position.

In some embodiments, methods of making a dumping device further comprise providing a spring mechanism attached between a container and the frame. In some embodiments, the frame further comprises a sliding rail system by which a container is able to be moved in a lateral direction relative to the frame.

This Summary is not intended to identify key features or essential features of the claimed subject matter, nor is it intended to be used as an aid in determining the scope of the claimed subject matter.

Additional features and advantages of exemplary implementations of the present disclosure will be set forth below, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF DRAWINGS

The components in the figures are not necessarily to scale, emphasis instead being placed upon illustrating the principles of the invention. In the figures, like reference numerals designate corresponding parts throughout the different views.

FIG. 1: is a side view schematic of one embodiment of a manually operated dumping device in the upright and locked position.

FIG. 2: is a side view schematic of one embodiment of a manually operated dumping device in the extended delivery position.

FIG. 3: is a side view schematic of one embodiment of a structural frame and components of a manually operated dumping device in the locked position.

FIG. 4: is a top down schematic of one embodiment of a spring and chain mechanism s of a manually operated dumping device in the locked position.

FIG. 5: is a top down schematic of one embodiment of a spring and chain mechanism of a manually operated dumping device in the extended position to allow for dumping.

FIG. 6: is a side view schematic of one embodiment of a nylon strap mechanism of a manually operated dumping device in the extended position to allow for dumping.

### DETAILED DESCRIPTION OF DRAWINGS

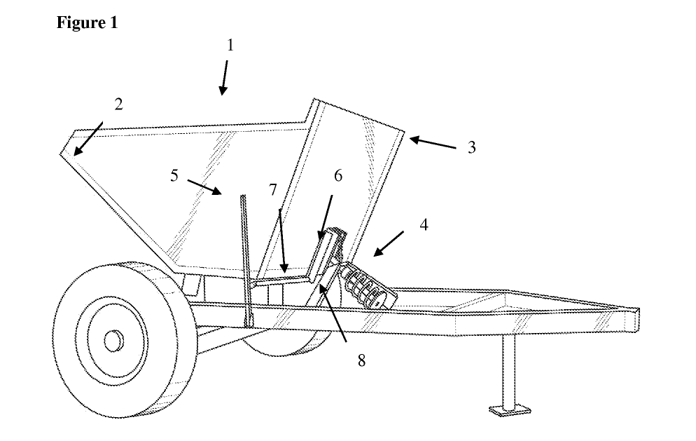

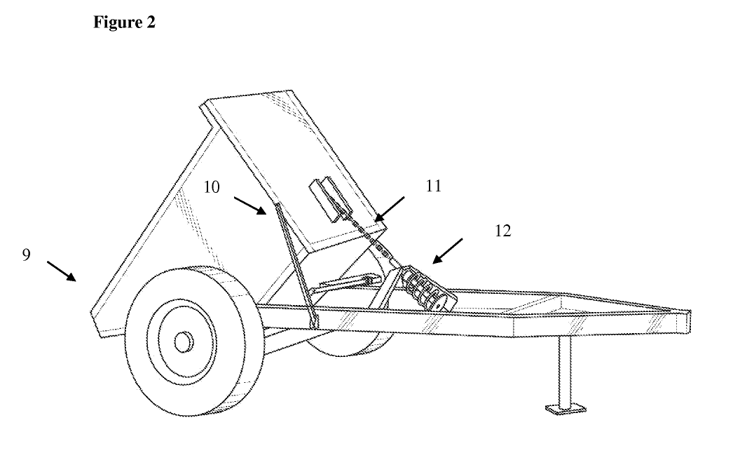

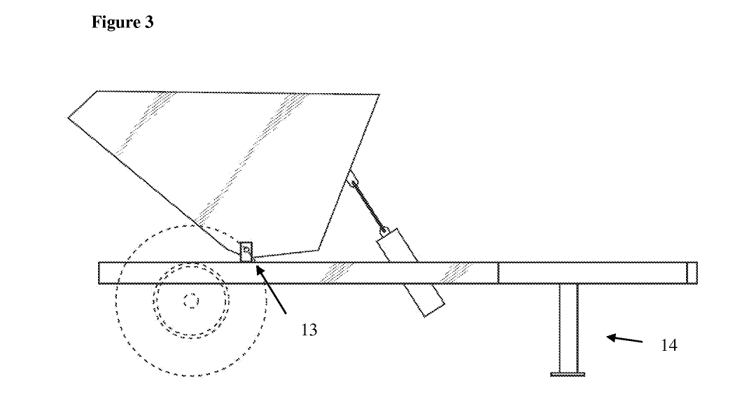

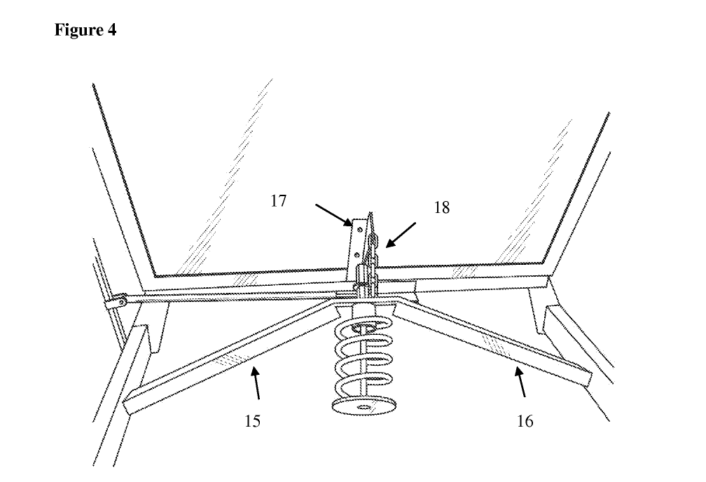

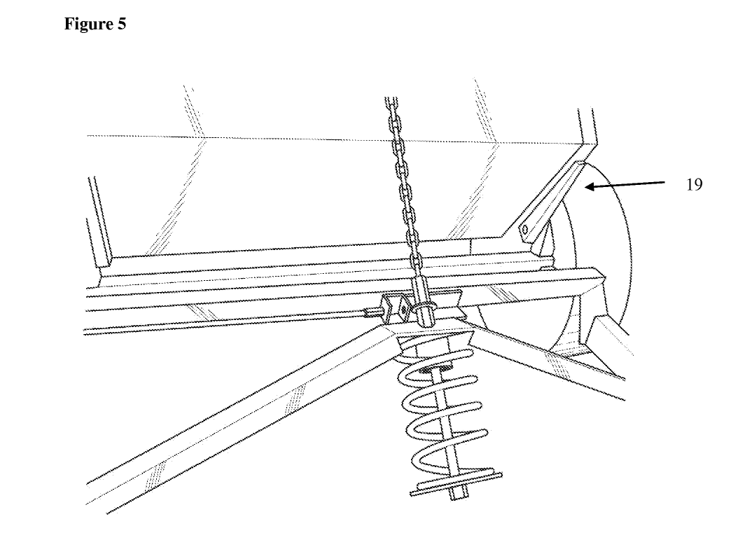

Referring now to FIG. 1 of the drawings, a slightly elevated diagonal side view of the dump truck trailer is shown in the load carrying position having a chassis or frame and a pivotable load or cargo carrying dump body 1 with vertical sides 3 and slanted vertical back 2 to form a storage space, and a dumping and spring mechanism (FIGS. 4 and 5). A rear 2 of the load carrying dump body 1 constructed at a 30 to 60 degree inclination to the chassis or frame and the ground encloses the contents of the load carrying dump body 1 when erect (FIG. 3). The dumping release lever 5 is attached to the side of the chassis or frame actuated by pulling the lever 5 horizontally away from the load carrying dump body. When actuated, the lever 5 horizontally slides a pin 8 out of an aperture affixed to the load carrying dump body via a bracket or other locking mechanism 6. Activation of dumping mechanism takes place at the side of the load carrying dump body, safely away from the point where the materials are to be dumped. Disengaging the locking mechanism by pulling the lever 5 releases the load carrying dump body 1 to move from the holding position to the dumping position, thereby dumping the load from a container. When the dumping mechanism is used, the load carrying dump body pivots on a horizontal access rotating the rear of the load carrying dump body to an angle of less than 0 degrees to the chassis or frame and the ground. The cargo to be removed slides by gravity down the bed of load carrying body, when it is in the tilted or elevated position, as shown in FIG. 2, by actuating the dumping mechanism. The spring mechanism 4 is attached to the chassis or frame with a chain 11 emanating from the spring mechanism attaching to the load carrying dump body 1 at the bracket 6.

Referring now to FIG. 2 of the drawing, a slightly elevated diagonal side view of the dump truck trailer is shown in the load dumping position having a chassis or frame and a pivotable load or cargo carrying dump body 1 with vertical sides and slanted vertical back to form a storage space, and an activated dumping mechanism. Here, the load carrying dump body 1 has pivotally rotated along a horizontal access relative to the chassis or frame and ground from the load carrying position (FIG. 1) to achieve an angle of less than 0 degrees. The locking mechanism 6 has been released by the lever 10 beside the load carrying dump body 1. The spring mechanism 12 and associated chain 11 is in the fully extended position whereby the force released by the locking mechanism 6 is lessened by the compression of the spring mechanism 12 to slow the impact of the pivoting load carrying dump body 1.

Referring now to FIG. 3 of the drawing, a side view schematic of a structural frame absent the locking mechanism with a see through view of the wheels is shown. The front portion of the chassis or frame is stabilized by a vertical landing strut 14 attached to the front chassis or frame to ensure vertical stability. The spring mechanism 12 is shown being attached to both the chassis or frame and the load carrying dump body 1 by a chain 11. The load carrying dump body 1 rotates on the axis of a bracket or hinge 13 attached to the frame or chassis behind the wheels. This bracket or hinge 13 holds a cylindrical pin attaching this bracket to a triangular stabilizing piece of metal 19 extending along the underside of load carrying dump body to assist in the rotation along the horizontal axis. A view of the inside of the bracket can be seen in FIG. 5.

Referring now to FIG. 4 of the drawings, a top down schematic of a locking mechanism and spring and chain mechanism attached to the load carrying dump body is shown in the load carrying position. Two metal bars 15 and 16 extend from the chassis or frame angled slightly vertically in relation to the frame, converging on the spring and chain mechanism but stopping short of intersection. A horizontal metal bar runs between the two converging metal bars 15 and 16 extending from the chassis or frame and provides structural support and stability for the spring mechanism. These horizontal metal bars 15 and 16 provide an anchor point for the spring mechanism 12. A metal chain 18 is attached to the end of the spring mechanism 12 closest to the load carrying dump body 1 and to a metal bracket 17 hinged at approximately 90 degrees extending outward from the load carrying dump body. This metal bracket 17 is attached to the load carrying dump body 1 by overlaying another metal plate flat against the portion of the hinged metal plate lying flat along load carrying dump body 1 and riveting two metal rivets through both metal plates and into the load carrying dump body.

When the load carrying dump body 1 is released from the load carrying position (FIG. 1) to the load dumping position (FIG. 2), the chain 18 will pull on the spring mechanism's coiled body. The spring mechanism 12 will be compressed against the horizontal metal bar as the load carrying dump body is lowered, slowing its descent (FIG. 4). A plurality of numbers and sizes of the spring mechanism 12 and its corresponding tension can be increased or decreased to support a greater or lesser load capacity.

In certain embodiments a locking mechanism for the trailer is simply a modified and commonly known dead-bolt 8. Regarding the male portion of the lock bolt, may comprise of a 0.5 inch diameter metal rod attached to a lever that is anchored to the frame of the trailer. A metal rod is approximately 24 inches long along the axis and has a guide to ensure that it does not displace or migrate along the axis. A guide is 0.5 inch ID pipe that measures six inches in length. Regarding the female portion of the lock bolt, may comprise of three 0.5 inch diameter aligned holes. A single hole is located on the dump body and the remaining two holes are located on the frame of the trailer. When the dump body is at the resting position all three holes become aligned allowing the dead-bolt to slide thru the locking mechanism.

Referring now to FIG. 5 of the drawings, a slightly diagonal top down schematic view of a locking mechanism and spring and chain mechanism attached to the load carrying dump body 1 is shown in the load dumping position. Here, the chain 11 attached to the load carrying dump body 1 by the hinged metal plate and the end of the spring mechanism 12 is extended. The downward force exerted on the load carrying dump body is transferred through the chain 11 to the coiled spring 12 pressing against the horizontal metal bar.

Here, the locking mechanism has released the load carrying dump body, allowing the weight of the load to pull downward on the load carrying dump body. The load carrying dump body rotates along the axis of the bracket or hinge located behind the wheels. The triangular stabilizing piece of metal 19 attached by a cylindrical metal pin to the bracket or hinge distributes the force along the underside of the load carrying dump body 1 increasing stability and aiding in the rotation along the horizontal axis.

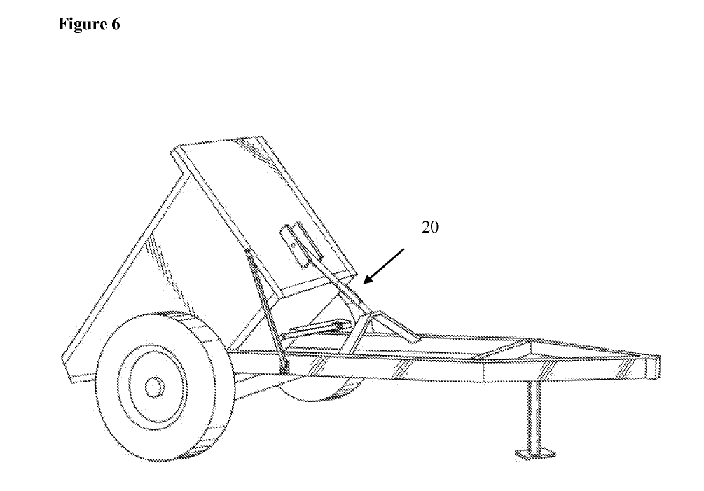

Referring now to FIG. 6, a slightly diagonal side view schematic of one embodiment of the manually operated dumping device in the load carrying position where nylon strap mechanisms supplement or replace the spring mechanism is shown. Nylon rope or strap 20 will be attached to both outward facing sides of the frame or chassis with common devices used to secure heavy loads in this field of invention. The thickness of the nylon rope 20 which can easily be replaced or supplemented will depend on the load weight of a particular job. Additionally or alternatively, a plurality of nylon ropes may be used to vary the load weight.

We claim:

1. A manually operated dumping device comprising:
a container configured to occupy a holding position and a dumping position, a container being configured to hold a load when in the holding position, a container having a center of gravity;
a frame configured to support a container, the frame having a forward portion and a rearward portion;
a locking mechanism configured to releasably secure a container in the holding position;
wherein a container is secured to the frame at a pivot point, the pivot point being located forward of the center of gravity of a container, and
wherein disengaging the locking mechanism allows a container to move from the holding position to the dumping position, thereby dumping the load from a container.

2. The device of claim 1, wherein the frame comprises a trailer configured to be attached to a vehicle.

3. The device of claim 1, wherein at least a portion of the frame defines a first plane, and a rearward portion of the container defines a second plane, wherein an angle between the first and second planes is between approximately 30° and 60°, wherein the dumping position is achieved when an angle between the first and second planes is less than 0°.

4. The device of claim 1, wherein the pivot point is positioned so as to allow a user to manually move a container from the dumping position to the holding position.

5. The device of claim 1, wherein a frame further comprises a sliding mechanism configured to allow for the pivot point to be moved relative to the frame so as move a container laterally along the frame from a forward position to a rearward position.

6. The device of claim 1, wherein the center of gravity of a container—when in the holding position—does not substantially change when a container is filled with a load; wherein a container comprises four sides, a first side toward the forward portion of the frame two angled sides, a second side toward the rearward portion of the frame, wherein the first and second sides are angled away from each other.

7. The device of claim 1, wherein the frame is configured to provide a counterbalance to a container when a container is in the dumping position:
wherein a forward portion the frame is secured to a vehicle;
wherein the frame further comprises a weighted portion positioned forward of a container.

8. The device of claim 1, wherein the device further comprises a spring mechanism attached to the frame and to a container:
wherein the spring mechanism is configured to halt the movement of a container when it transitions from the holding position to the dumping position;
wherein the spring mechanism is configured to dampen the falling force of a container as it transitions from the holding position to the dumping position;
wherein the spring mechanism is configured to assist a user in returning a container from the dumping position to the holding position; and
wherein the spring mechanism comprises a rod connected at a first end to a container and at a second end to a spring, wherein the spring is secured to the frame.

9. A method of operating a dumping device comprising:
releasing a locking mechanism so to allow a container to transition from a holding position to a dumping position;
wherein a container is configured to hold a load when in the holding position, a container being supported by a frame, and
wherein a container is secured to the frame at a pivot point, the pivot point being located forward of a center of gravity of a container.

10. A method of making a dumping device comprising:
providing a container frame apparatus;
providing a container configured to hold a load when in a holding position, a container being secured to the frame by at least one pivot point, a container having a center of gravity, the pivot point being located forward of the center of gravity; and
providing a locking mechanism configured to releasably secure a container in the holding position;
further comprising providing a spring mechanism attached between a container and the frame;
wherein the frame further comprises a sliding rail system by which a container is able to be moved in a lateral direction relative to the frame.
